(19) United States
(12) Patent Application Publication
(10) Pub. No.: US 2024/0303540 A1
(43) Pub. Date: Sep. 12, 2024

(54) PREDICTION DEVICE, PREDICTION METHOD, AND RECORDING MEDIUM

(71) Applicant: NEC Corporation, Minato-ku, Tokyo (JP)

(72) Inventor: Aya Ogata, Tokyo (JP)

(73) Assignee: NEC Corporation, Minato-ku, Tokyo (JP)

(21) Appl. No.: 18/279,521

(22) PCT Filed: Mar. 1, 2022
(86) PCT No.: PCT/JP2022/008533

§ 371 Date: Aug. 30, 2023

(30) Foreign Application Priority Data
Mar. 4, 2021 (JP) 2021-034393

(51) Int. Cl. G06N 20/00; E21B 47/003

(52) U.S. Cl. CPC G06N 20/00; E21B 47/003; E21B 2200/20; E21B 2200/22

(57) ABSTRACT

In a prediction device, an acquisition means acquires a feature quantity related to a well of shale gas or shale oil. A prediction means calculates a predicted value of a production volume of the well or a sand return amount of the well, based on the feature quantity, using a machine learning model. An output means outputs the predicted value and a contribution degree of the feature quantity to the predicted value.

### TECHNICAL FIELD

The present disclosure relates to a technique for making predictions related to resource development using AI (Artificial Intelligence).

### BACKGROUND ART

There is known a technique for making predictions related to resource development using AI. For example, Patent Document 1 discloses a method for presuming petroleum physical properties of a hydrocarbon reservoir using a neural network (NN).

### PRECEDING TECHNICAL REFERENCES

### Patent Document

Patent Document 1: Japanese Patent Application Laid-Open under No. 2020-534456

### SUMMARY

### Problem to be Solved

Since Patent Document 1 is not assumed to be used in the mining of shale gas or shale oil, it is not applicable to the mining of shale gas or shale oil. Further, since the method of Patent Document 1 utilizes a neural network, there is a problem that the interpretability of the obtained prediction result is low.

It is an object of the present disclosure to present predictions related to the development of shale gas and shale oil in a highly interpretable manner.

### Means for Solving the Problem

According to an example aspect of the present disclosure, there is provided a prediction device comprising:
an acquisition means configured to acquire a feature quantity related to a well of shale gas or shale oil;
a prediction means configured to calculate a predicted value of a production volume of the well or a sand return amount of the well, based on the feature quantity, using a machine learning model; and
an output means configured to output the predicted value and a contribution degree of the feature quantity to the predicted value.

According to another example aspect of the present disclosure, there is provided a prediction method comprising:
acquiring a feature quantity related to a well of shale gas or shale oil;
calculating a predicted value of a production volume of the well or a sand return amount of the well, based on the feature quantity, using a machine learning model; and
outputting the predicted value and a contribution degree of the feature quantity to the predicted value.

According to still another example aspect of the present disclosure, there is provided a recording medium storing a program, the program causing a computer to:
a acquire a feature quantity related to a well of shale gas or shale oil;
calculate a predicted value of a production volume of the well or a sand return amount of the well, based on the feature quantity, using a machine learning model; and
output the predicted value and a contribution degree of the feature quantity to the predicted value.

### Effect

According to the present disclosure, it is possible to present predictions related to the development of shale gas or shale oil in a highly interpretable manner.

### BRIEF DESCRIPTION OF THE DRAWINGS

FIG. 1 is a diagram for explaining basic steps of a method of mining shale gas and oil.

FIG. 2 shows a prediction device according to a first example embodiment.

FIG. 3 shows a hardware configuration of the prediction device according to the first example embodiment.

FIG. 4 shows a functional configuration of the prediction device of the first example embodiment for model generation.

FIG. 5 schematically shows an example of a structure of a prediction model using heterogeneous mixture learning.

FIG. 6 shows an example of a prediction model for predicting production volume of shale gas and oil.

FIG. 7 is a diagram for explaining prediction formulas in the prediction model of FIG. 6.

FIG. 8 shows an example of a prediction model for predicting a sand return amount in a development of shale gas and oil.

FIG. 9 is a diagram for explaining prediction formulas in the prediction model of FIG. 8.

FIG. 10 shows a functional configuration of the prediction device according to the first example embodiment.

FIG. 11 is a flowchart of prediction processing by the prediction device according to the first example embodiment.

FIG. 12 shows a functional configuration of a prediction device according to a second example embodiment.

FIG. 13 is a flowchart of prediction processing by the prediction device according to the second example embodiment.

FIG. 14 shows a functional configuration of a prediction device according to a third example embodiment.

FIG. 15 is a flowchart of processing by the prediction device according to the third example embodiment.

### EXAMPLE EMBODIMENTS

Preferred example embodiments of the present disclosure will be described with reference to the accompanying drawings.

### <Shale Development>

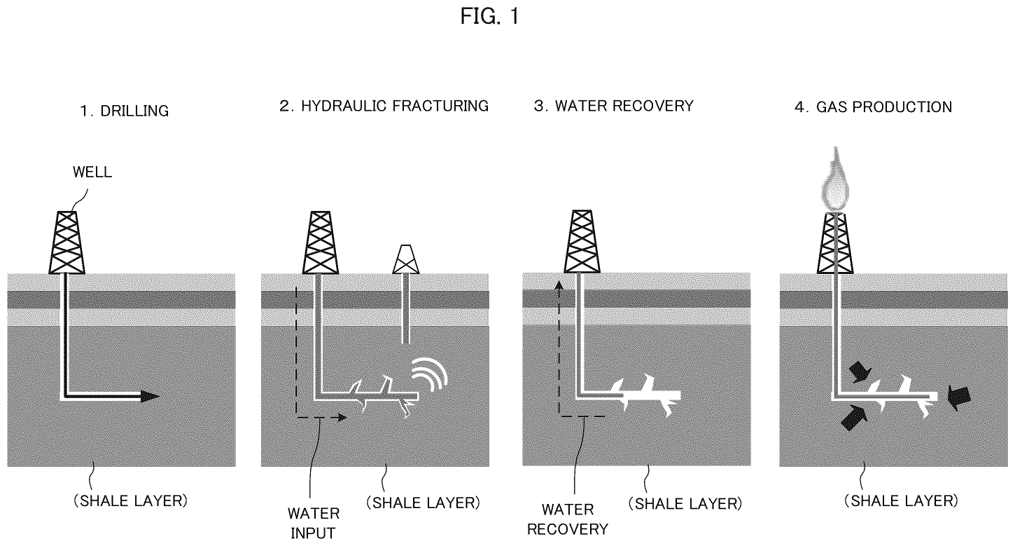

First, as a premise, the basic flow of the development of shale oil and shale gas (also called “shale development”) will be explained. FIG. 1 is a diagram illustrating the basic steps of the method of mining shale gas. The method of mining shale oil is basically the same.

Shale gas and shale oil are natural gas and crude oil extracted from the shale layer, which is a stratum of sedimentary rock called shale. As shown, mining of shale gas is basically carried out in the sequence of drilling, hydraulic fracturing, water recovery, and gas production. Specifically, in the drilling process, a steel pipe with a drill tip is used to excavate a well horizontally in the shale layer deep in the ground. Next, in the hydraulic fracturing process, high-pressure water containing sand (proppant) is sent to create artificial cracks in the shale layer. Subsequently, in the water recovery process, water used for the hydraulic fracturing is recovered to secure a flow path for gas. Then, the production of gas is started.

Since shale development still has a short history and the development factors are enormous, the optimum development methodology has not been established. Therefore, development is often carried out by the method of trial and error. There is a problem that profitability deteriorates as a result of developing a well with low productivity or overspending the completion cost. Therefore, it is expected to predict productivity by machine learning using enormous data obtained in the past. By using the technique such as deep learning using a neural network, the prediction of the productivity is possible. However, since the interpretability of the obtained prediction result is low, it is not clear what kind of factor contributes to the prediction result and how much the factor contributes to the prediction result. In the following example embodiments, when predicting the productivity of shale gas or shale oil using machine learning, it is possible to present the prediction results in a highly interpretable manner.

### First Example Embodiment

### [Basic Configuration]

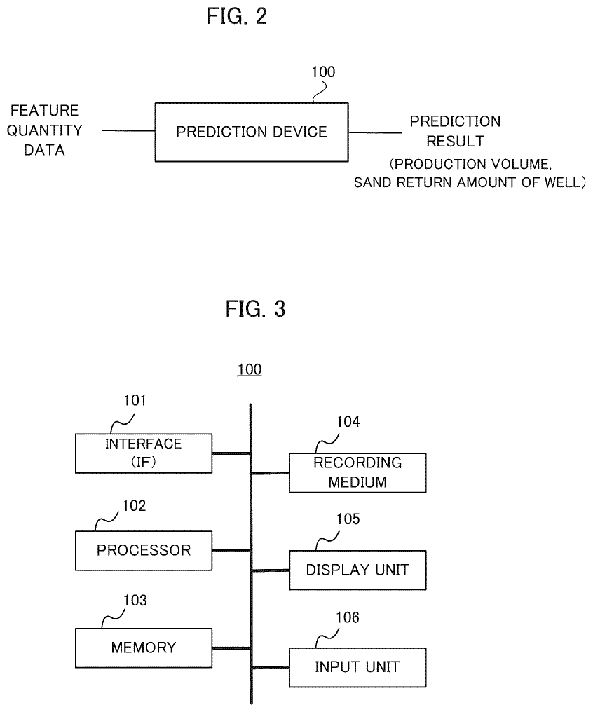

FIG. 2 shows a prediction device 100 according to a first example embodiment. The prediction device 100 performs predictions associated with shale development. Specifically, to the prediction device 100, feature quantity data indicating various feature quantities related to shale development are inputted. The prediction device 100 predicts, from the feature quantity data, elements affecting the development plan of the shale gas or the shale oil by machine learning. Specifically, the prediction device 100 predicts the production volume of the well, the sand return amount of the well, and the like and outputs the prediction results.

The feature quantity data indicates the feature quantity related to the position of the well, geology, mining, completion, and production. The feature quantities related to the location of the well include, for example, a country, a region, latitude and longitude, etc. The feature quantities related to geology include, for example, mining areas, strata, porosity, permeability, water saturation, salinity, etc. The feature quantities related to mining include, for example, mining depth, lateral length, well spacing, horizontal undulation, drilling period, drilling contractor, etc. The feature quantity related to the completion includes, for example, number of stages, number of clusters, type/particle size of sand, type/quantity/viscosity of fluid (water), press-fit pressure, casing type, etc. The feature quantities related to production include water recovery quantity, sand recovery quantity, recovery quantity/ratio of gas and oil, etc.

### [Hardware Configuration]

FIG. 3 is a block diagram illustrating a hardware configuration of the prediction device 100. The prediction device 100 includes an interface (IF) 101, a processor 102, a memory 103, a recording medium 104, a display unit 105, and an input unit 106.

The IF 101 inputs and outputs data to and from the prediction device 100. Specifically, the IF 101 is used for inputting various feature quantity data related to the shale development and outputting prediction results to the outside.

The processor 102 is a computer, such as a CPU, that controls the entire prediction device 100 by executing a program prepared in advance. The processor 102 may be a GPU (Graphics Processing Unit), an FPGA (Field-Programmable Gate Array), or the like. Specifically, the processor 102 executes the prediction processing described later.

The memory 103 may be a ROM (Read Only Memory), a RAM (Random Access Memory), and the like. The memory 103 stores information about the prediction model used by the prediction device 100. The memory 103 is also used as a working memory during various processes by the processor 102.

The recording medium 104 is a non-volatile and non-transitory recording medium such as a disk-like recording medium or a semiconductor memory and is configured to be detachable from the prediction device 100. The recording medium 104 records various programs executed by the processor 102. When the prediction device 100 executes the processes, the program recorded in the recording medium 104 is loaded into the memory 103 and executed by the processor 102.

The display unit 105 is, for example, a liquid crystal display device, and displays various types of information to the user. The input unit 106 may be, for example, a keyboard, mouse, or the like, and is used by a user to perform various instructions and inputs.

### [Function Configuration in Model Generation]

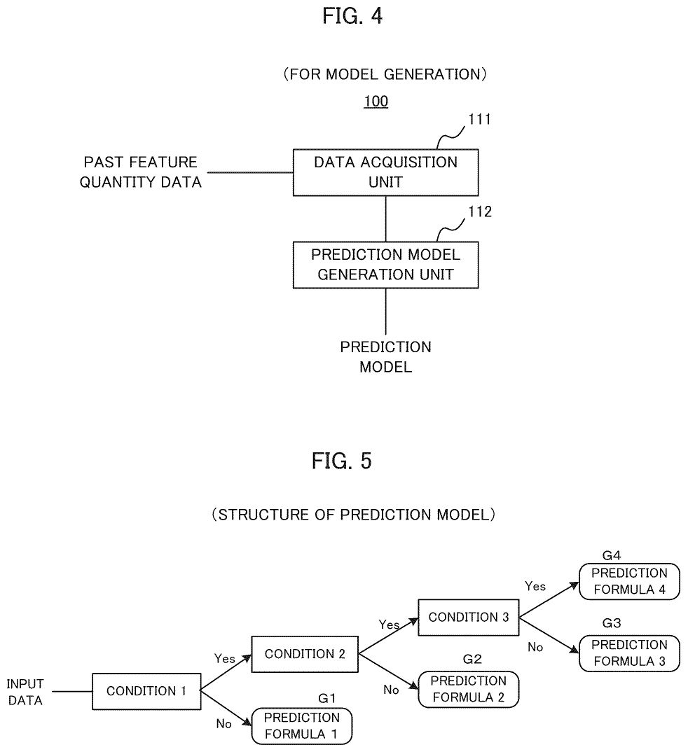

FIG. 4 is a block diagram illustrating a functional configuration of the prediction device 100 for model generation. For generating a model, i.e., for training a model, the prediction device 100 includes a data acquisition unit 111 and a prediction model generation unit 112. The data acquisition unit 111 outputs various past feature quantity data related to shale development to the prediction model generation unit 112 as training data. The prediction model generation unit 112 trains the prediction model using the training data and outputs the prediction model after the training. The resulting prediction model is stored in the memory 103 or the like. When generating the prediction model, the prediction model may be trained by dividing the training data for each region where shale development is performed, specifically, for each country or for each latitude and longitude.

In this example embodiment, the prediction model generation unit 112 generates the prediction model by heterogeneous mixture learning. The heterogeneous mixture learning is a technique which automatically discovers specific regularities from a wide variety of data to group the data based on the regularities, and perform prediction using appropriate regularity for each group. The prediction model generated by the heterogeneous mixture learning is a combination of a tree structure indicating conditions for selecting prediction formulas and linear prediction formulas.

Specifically, when the past feature quantity data related to the shale development is inputted, the prediction model generation unit 112 first analyzes the patterns and trends to group (case divide) the data, and generates a prediction formula conforming to the regularity of the data belonging to each group. For example, when the prediction device 100 predicts the production volume of the shale gas, the prediction model generation unit 112 generates a prediction formula that predicts the production volume of the shale gas for each group using the past feature quantity data and the past actual production volumes. The technique of the heterogeneous mixture learning is disclosed, for example, in U.S. Published Patent US2014/0222741A1 Publication, and its disclosure is incorporated herein by reference.

FIG. 5 schematically shows an example of the structure of a prediction model using the heterogeneous mixture learning. In this example, all the data are divided into four groups G1 to G4 according to Conditions 1 to 4, and the prediction is performed using the prediction formula corresponding to the data of each group. For example, the prediction formula 1 is used for the prediction of the data belonging to the group G1 for which Condition 1 is No. In addition, the prediction formula 2 is used for the prediction of the data belonging to the group G2 for which Condition 1 is Yes and Condition 2 is No. Thus, an appropriate prediction formula is used for the prediction of the data of each group. Thus, it is possible to automatically discover the regularities of those data and to make an appropriate prediction for each of the groups, even when a wide variety of data related to shale development are mixed.

### EXAMPLES OF PREDICTION MODEL

Next, examples of the prediction model generated using the heterogeneous mixture learning is explained. The data items used in the following examples are only examples, and may be different from the data items actually used.

### Example 1

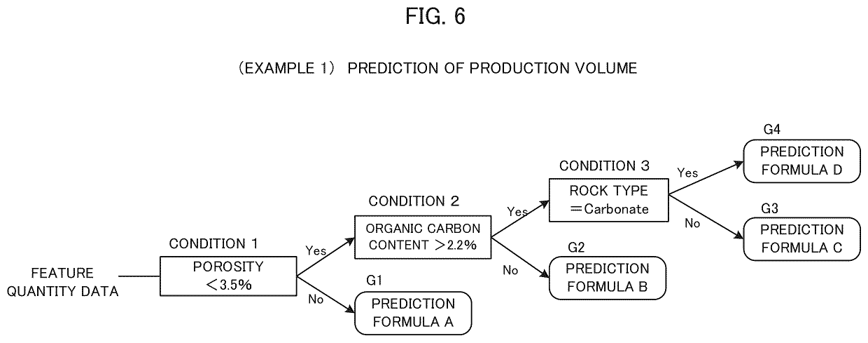

FIG. 6 shows an example of a prediction model for predicting production volume of shale gas and oil. In this case, the inputted feature quantity data are divided into four groups G1 to G4 by Condition 1 (porosity <3.5%), Condition 2 (Organic carbon content >2.2%), and Condition 3 (Rock type=Carbonate). For each of the groups G1 to G4, a prediction formula corresponding to that group is generated.

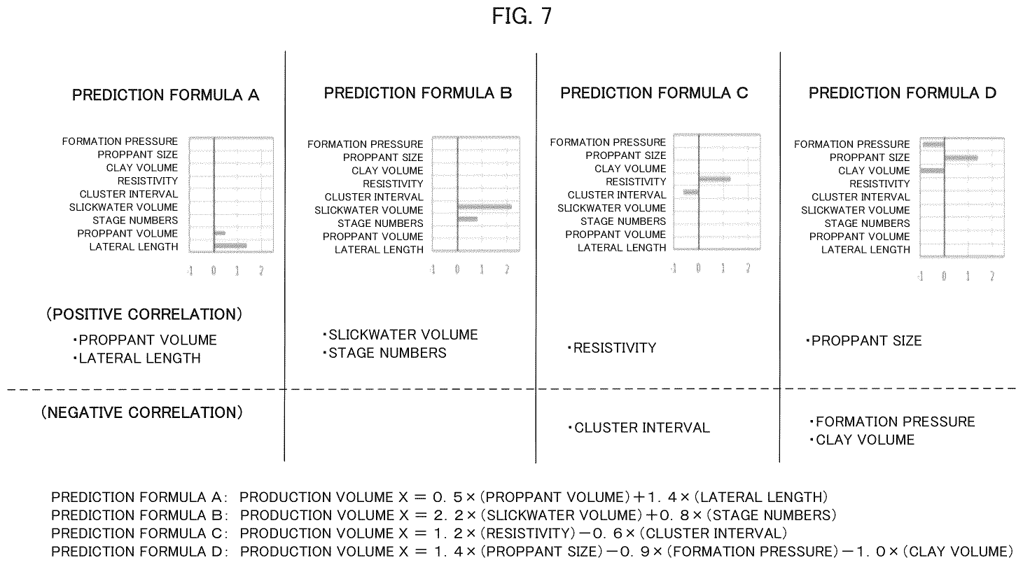

FIG. 7 is a diagram illustrating prediction formulas. As the feature quantity data inputted, nine parameters including formation pressure, proppant size, clay volume, resistivity, cluster interval, slickwater volume, stage numbers, proppant volume, and lateral length are used. It should be noted that the above parameters are merely examples, and in practice, a larger number of parameters may be used. The graph corresponding to each prediction formula A to D shows the contribution degree of each parameter to the production volume in each prediction formula. For example, in the prediction formula A, out of the nine parameters mentioned above, the proppant volume and the lateral length contribute to the prediction volume. As shown in the graph, the contribution degree of the proppant volume is about 0.5 and the contribution degree of the lateral length is about 1.4. In the prediction formula A, other seven parameters do not contribute to the production volume. The parameters may be classified into parameters having a positive correlation with the production volume and parameters having a negative correlation. The parameters having a positive correlation contribute to the direction in which the production volume increases, and the parameters having a negative correlation contribute to the direction in which the production volume decreases.

In the case of the prediction formula A, the contribution degree of the proppant volume is about 0.5, the contribution degree of the lateral length is about 1.4, and other parameters have a contribution degree of 0. Therefore, the prediction formula A is obtained as follows.

$$Production volume X = 0.5 \times ( Proppant volume ) + 1.4 \times ( Lateral length )$$

Similarly, the prediction formulas B to D are also derived as shown in FIG. 7 based on each graph.

### Example 2

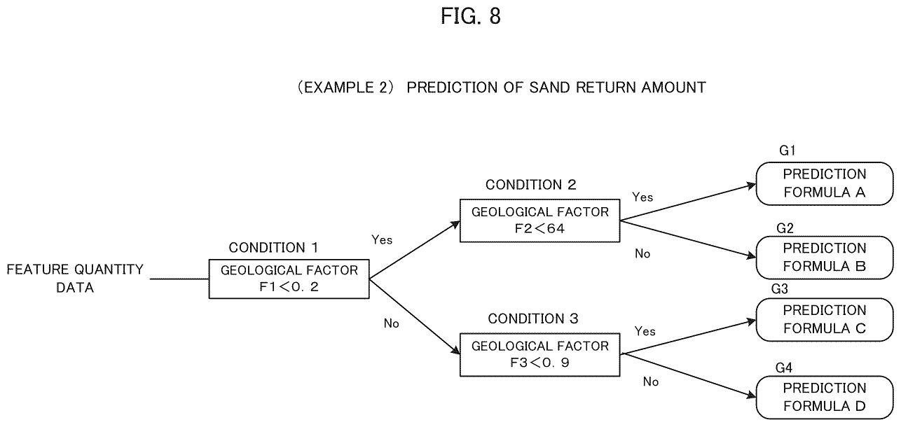

FIG. 8 shows an example of a prediction model for predicting the sand return amount in the development of shale gas and oil. The sand return amount refers to the amount of sand (proppant) that is charged in the hydraulic fracturing process shown in FIG. 1 and is returned back in the water recovery process. When the sand return amount is large, it is necessary to re-charge the sand to maintain the cracks formed in the shale layer, which leads to an increase in cost. Therefore, the sand return amount needs to be considered in the development plan.

In this example, the feature quantity data inputted are divided into four groups G1 to G4 by Condition 1 (Geological factor F1<0.2), Condition 2 (Geological factor F2<64), and Condition 3 (Geological factor F3<0.9). For each of the groups G1 to G4, a prediction formula corresponding to that group is generated.

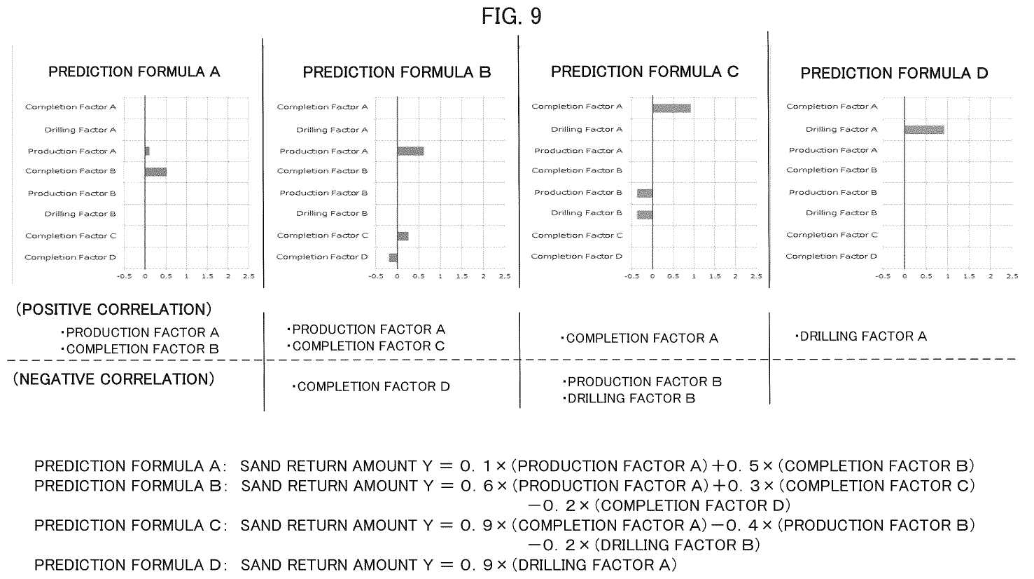

FIG. 9 is a diagram for explaining the prediction formulas. As the feature quantity data inputted, eight factors including the completion factors A to D, the drilling factors A and B, and the production factors A and B, are used. Incidentally, each factor described above is merely an example, and a larger number of feature quantity data may be used in practice. The graph corresponding to each prediction formula A to D shows the contribution degree of each factor to the sand return amount in each prediction formula. For example, in the prediction formula A, among the eight factors mentioned above, the production factor A and the completion factor B contribute to the prediction of the sand return amount. As shown in the graph, the contribution degree of the production factor A is about 0.1 and the contribution degree of the completion factor B is about 0.5. In the prediction formula A, other six factors do not contribute to the sand return amount. Similarly to the first example, there are factors having a negative correlation and factors having a positive correlation.

In the case of the prediction formula A, the contribution degree of the production factor A is about 0.1, the contribution degree of the completion factor B is about 0.5, and the contribution degree of other factors are 0. Therefore, the prediction formula A is obtained as follows.

$$Sand return amount Y = 0.1 \times ( Production factor A ) + 0.5 \times ( Completion factor B )$$

Similarly, the prediction formulas B to D are also derived based on each graph as shown in FIG. 9.

As described above by using the first example and the second example, in the prediction model using the heterogeneous mixture learning, the input data are grouped by several conditions, and the prediction is performed using an appropriate prediction formula for each group. Therefore, the user can understand in which conditions the production volume and the sand return amount are predicted and which feature quantity contributes to the prediction of the production volume and the sand return amount, by looking at the prediction results, the content of the tree structure (by what conditions the tree is divided) and the prediction formulas used to calculate the prediction results. Therefore, the prediction results can be effectively used for development planning, etc.

### [Functional Configuration for Prediction]

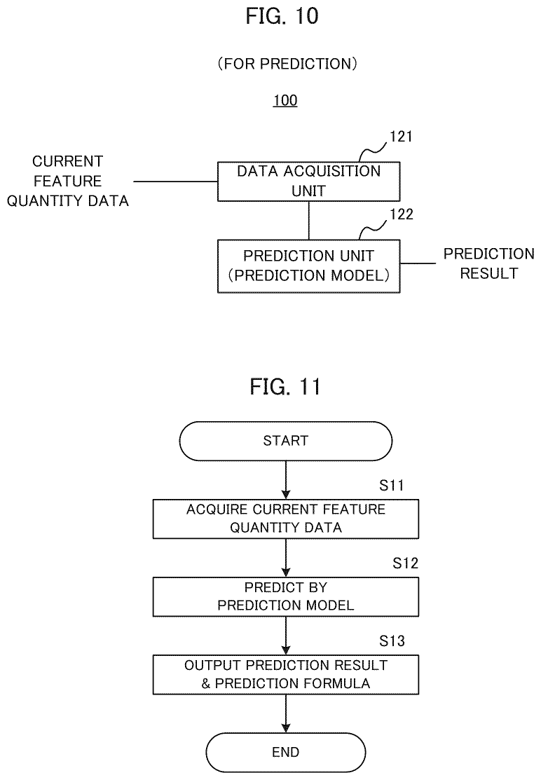

FIG. 10 is a block diagram illustrating a functional configuration of the prediction device 100 for prediction. The prediction device 100 for prediction includes a data acquisition unit 121 and a prediction unit 122. The data acquisition unit 121 is an example of an acquisition means, and the prediction unit 122 is an example of a prediction means.

The data acquisition unit 121 acquires the current feature quantity data related to the shale development and outputs the data to the prediction unit 122.

The prediction unit 122 performs prediction using a prediction model generated by the above-described heterogeneous mixture learning. Specifically, the prediction unit 122 predicts the production volume, the sand return amount, or the like of the shale gas according to the grouping and prediction formulas exemplified in FIGS. 6 to 9 based on the inputted current feature quantity data. Specifically, the prediction unit 122 determines one group based on the inputted feature quantity data, and calculates a predicted value such as a production volume of shale gas or a sand return amount using the prediction formula corresponding to the group as a prediction result.

Then, the prediction unit 122 outputs the prediction result and the prediction formula used for the prediction. For example, in the prediction of the production volume of the shale gas shown in FIG. 6, when the current feature quantity data does not correspond to the Condition 1 and the prediction unit 122 calculates the predicted value of the production volume using the prediction formula A, the prediction unit 122 outputs the calculated prediction result and the prediction formula A. The prediction unit 122 may also output conditions of grouping corresponding to the prediction formula, together with the prediction formula. That is, in the above example, the prediction unit 122 may output the prediction result, the prediction formula A, and the Condition 1 corresponding to the prediction formula A. The prediction result and the prediction formula thus outputted are displayed on the display unit 105, for example.

### [Prediction Processing]

FIG. 11 is a flowchart of prediction processing performed by the prediction device 100. This processing is realized by the processor 102 shown in FIG. 2, which executes a program prepared in advance and operates as the elements shown in FIG. 10.

First, the data acquisition unit 121 acquires the current feature quantity data (step S11). Next, the prediction unit 122 performs prediction using the prediction model generated in advance (step S12). For example, in the above-described first example and second example, the prediction unit 122 predicts the production volume or the sand return amount of the shale oil. Next, the prediction unit 122 outputs the prediction result and the prediction formula used for the prediction (step S13). Then, the processing ends.

### Second Example Embodiment

In the above-described first example embodiment, prediction is performed using a highly interpretable prediction model generated by the heterogeneous mixture learning. In the second example embodiment, instead of making the prediction model itself a highly interpretable model, the interpretability for the prediction result is guaranteed by outputting the auxiliary information which supplements the interpretability of the prediction by the prediction model.

### [Functional Configuration]

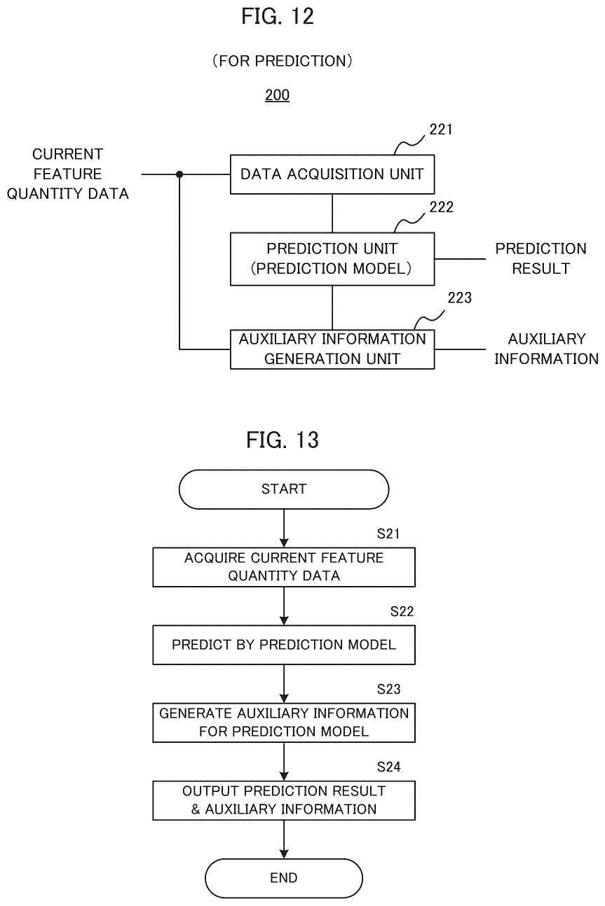

FIG. 12 is a block diagram showing a functional configuration of a prediction device 200 according to the second example embodiment. The hardware configuration of the prediction device 200 is the same as that of the prediction device 100 of the first example embodiment. The prediction device 200 includes a data acquisition unit 221, a prediction unit 222, and an auxiliary information generation unit 223. The data acquisition unit 221 is an example of an acquisition means, the prediction unit 222 is an example of a prediction means, and the auxiliary information generation unit 223 is an example of an auxiliary information generation means.

The data acquisition unit 221 acquires the feature quantity data related to the shale development and outputs the feature quantity data to the prediction unit 222.

The prediction unit 222 does not need to use a machine learning model with high interpretability, and can use a model of deep learning using a neural network, for example. The prediction unit 222 performs prediction using a prediction model that is trained using the past feature quantity data related to shale development, and outputs the prediction result.

The auxiliary information generation unit 223 generates the auxiliary information to supplement the interpretability of the machine learning model used by the prediction unit 222. The auxiliary information is information indicating the basis of prediction by the machine learning model used by the prediction unit 222 or the like, and is generated using a technique generally called an explainable AI (XAI: Explainable AI). Specifically, the auxiliary information includes the following.

### (1) Auxiliary Information Presenting a Global Explanation

The auxiliary information that presents the global explanation is information that approximately represents the prediction model used by the prediction unit 222 with the highly readable model. Specifically, the auxiliary information is expressed by approximating the target prediction model with a single decision tree or a rule model. In this example, the auxiliary data can be generated using techniques such as BATREE (Born Again Tree), defragTree, etc. For example, in BATREE, pseudo training data is generated using a learned model, and the decision tree is learned and presented using the generated pseudo training data.

### (2) Auxiliary Information Presenting a Local Explanation

The auxiliary information presenting the local explanation indicates the basis of prediction by the prediction model used by the prediction unit 222, and includes the following:

(1-1) Information that Presents the Feature Quantity on which the Prediction was Based

The auxiliary information can be information that indicates the feature quantity on which the prediction was based. That is, the auxiliary information indicates which feature quantity was important for the prediction. In this instance, the auxiliary information can be generated using techniques such as LIME, SHAP, ANCHOR, Grad-CAM, for example.

(1-2) Information Presenting the Training Data on which the Predictions were Based

The auxiliary information can be information that presents the training data on which the prediction was based. In this instance, the auxiliary information can be generated using techniques such as “influence”, for example. “Influence” provides information indicating how much the prediction result would change if a particular training data was missing.

### [Prediction Processing]

FIG. 13 is a flowchart of prediction processing performed by the prediction device 200. This processing is realized by the processor 102 shown in FIG. 2, which executes a program prepared in advance and operates as the elements shown in FIG. 12.

First, the data acquisition unit 221 acquires the current feature quantity data (step S21). Next, the prediction unit 222 performs prediction using the prediction model generated in advance (step S22). Next, the auxiliary information generation unit 223 generates the auxiliary information that presents the basis of the prediction by the prediction model (step S23). Next, the prediction unit 222 and the auxiliary information generation unit 223 output the prediction result and the auxiliary information, respectively (step S24). Then, the processing ends.

Thus, according to the second example embodiment, even if a model called black-box model, which is less interpretable, is used as a prediction model, the lack of interpretability of the prediction model can be supplemented by presenting auxiliary information for that model.

### Third Example Embodiment

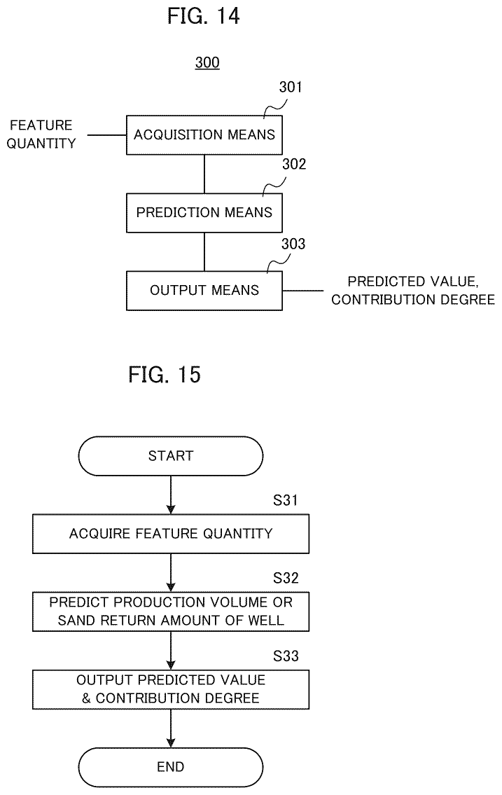

FIG. 14 is a block diagram illustrating a functional configuration of a prediction device 300 according to the third example embodiment. The prediction device 300 includes an acquisition means 301, a prediction means 302, and an output means 303.

FIG. 15 is a flowchart of processing performed by the prediction device 300 according to the third example embodiment. First, the acquisition means 301 acquires a feature quantity relating to a well of shale gas or shale oil (step S31). The prediction means 302 calculates a predicted value of a production volume or a sand return amount of the well using a machine learning model, based on the feature quantity (step S32). The output means 303 outputs the predicted value and contribution degree of the feature quantity to the predicted value (step S33). Then, the processing ends. The contribution degree is a value indicating how much each feature quantity contributed to the predicted value.

According to the prediction device 300 of the third example embodiment, in addition to the predicted value, the weight coefficient of the feature quantity with respect to the predicted value is outputted as the contribution degree. Therefore, the user can easily understand the reason why the predicted value is obtained.

A part or all of the above-described example embodiments (including modifications, the same shall apply hereinafter) may also be described as the following supplementary notes, but not limited thereto.

### (Supplementary Note 1)

A prediction device comprising:
an acquisition means configured to acquire a feature quantity related to a well of shale gas or shale oil;
a prediction means configured to calculate a predicted value of a production volume of the well or a sand return amount of the well, based on the feature quantity, using a machine learning model; and
an output means configured to output the predicted value and a contribution degree of the feature quantity to the predicted value.

### (Supplementary Note 2)

The prediction device according to Supplementary note 1,
wherein the machine learning model includes a plurality of linear prediction formulas for calculating the predicted value, and conditions for selecting the linear prediction formula used to calculate the predicted value based on the feature quantity, and
wherein the output means outputs a weight coefficient of the feature quantity in the linear prediction formula used to calculate the prediction value as the contribution degree.

### (Supplementary Note 3)

The prediction device according to Supplementary note 1, further comprising an auxiliary information generation means configured to generate auxiliary information indicating a basis of prediction using the machine learning model,
wherein the output means outputs the auxiliary information as the contribution degree of the feature quantity.

### (Supplementary Note 4)

The prediction device according to Supplementary note 3, wherein the auxiliary information is a feature quantity on which the prediction using the machine learning model is based or training data of the machine learning model on which the prediction is based.

### (Supplementary Note 5)

The prediction device according to Supplementary note 3, wherein the auxiliary information is information representing the machine learning model by a decision tree or a rule model.

### (Supplementary Note 6)

The prediction device according to any one of Supplementary notes 1 to 5, wherein the feature quantity includes information related to proppant used for the well.

### (Supplementary Note 7)

The prediction device according to any one of Supplementary notes 1 to 6, wherein the feature quantity includes information related to a fluid used for the well.

### (Supplementary Note 8)

The prediction device according to any one of Supplementary notes 1 to 7, wherein the machine learning model is trained using training data divided for each region.

### (Supplementary Note 9)

A prediction method comprising:
acquiring a feature quantity related to a well of shale gas or shale oil;
calculating a predicted value of a production volume of the well or a sand return amount of the well, based on the feature quantity, using a machine learning model; and
outputting the predicted value and a contribution degree of the feature quantity to the predicted value.

### (Supplementary Note 10)

A recording medium storing a program, the program causing a computer to:
a acquire a feature quantity related to a well of shale gas or shale oil;
calculate a predicted value of a production volume of the well or a sand return amount of the well, based on the feature quantity, using a machine learning model; and
output the predicted value and a contribution degree of the feature quantity to the predicted value.

While the present disclosure has been described with reference to the example embodiments, the present disclosure is not limited to the above example embodiments. Various changes that can be understood by those skilled in the art within the scope of the present disclosure can be made in the configuration and details of the present disclosure. In other words, it is needless to say that the present disclosure includes various modifications and alterations that could be made by a person skilled in the art according to the entire disclosure, including the scope of the claims, and the technical philosophy. In addition, each disclosure of the above-mentioned patent documents cited shall be incorporated with reference to this document.

### DESCRIPTION OF SYMBOLS

100, 200 Prediction device
102 Processor
111, 121, 221 Data acquisition unit
112 Prediction model generation unit
122, 222 Prediction unit
223 Auxiliary information generation unit

What is claimed is:

1. A prediction device comprising:
a memory configured to store instructions; and
one or more processors configured to execute the instructions to:
acquire a feature quantity related to a well of shale gas or shale oil;
calculate a predicted value of a production volume of the well or a sand return amount of the well, based on the feature quantity, using a machine learning model; and
output the predicted value and a contribution degree of the feature amount to the predicted value.

2. The prediction device according to claim 1,
wherein the machine learning model includes a plurality of linear prediction formulas for calculating the predicted value, and conditions for selecting the linear prediction formula used to calculate the predicted value based on the feature quantity, and
wherein the one or more processors output a weight coefficient of the feature quantity in the linear prediction formula used to calculate the prediction value as the contribution degree.

3. The prediction device according to claim 1,
wherein the one or more processors are further configured to execute the instructions to generate auxiliary information indicating a basis of prediction using the machine learning model,
wherein the one or more processors output the auxiliary information as the contribution degree of the feature quantity.

4. The prediction device according to claim 3, wherein the auxiliary information is a feature quantity on which the prediction using the machine learning model is based or training data of the machine learning model on which the prediction is based.

5. The prediction device according to claim 3, wherein the auxiliary information is information representing the machine learning model by a decision tree or a rule model.

6. The prediction device according to claim 1, wherein the feature quantity includes information related to proppant used for the well.

7. The prediction device according to claim 1, wherein the feature quantity includes information related to a fluid used for the well.

8. The prediction device according to claim 1, wherein the machine learning model is trained using training data divided for each region.

9. A prediction method comprising:
acquiring a feature quantity related to a well of shale gas or shale oil;
calculating a predicted value of a production volume of the well or a sand return amount of the well, based on the feature quantity, using a machine learning model; and
outputting the predicted value and a contribution degree of the feature amount to the predicted value.

10. A non-transitory computer-readable recording medium storing a program, the program causing a computer to:
a acquire a feature quantity related to a well of shale gas or shale oil;
calculate a predicted value of a production volume of the well or a sand return amount of the well, based on the feature quantity, using a machine learning model; and
output the predicted value and a contribution degree of the feature amount to the predicted value.
